(19) United States
(12) Patent Application Publication
(10) Pub. No.: US 2012/0298768 A1
(43) Pub. Date: Nov. 29, 2012

(54) LAWN WATERING APPARATUS AND METHOD OF USE

(75) Inventor: Robert Lukes, New Prague, MN (US)

(73) Assignee: LANDSCAPE TOOL MANUFACTURING, LLC, New Prague, MN (US)

(21) Appl. No.: 13/113,738

(22) Filed: May 23, 2011

(51) Int. Cl. A01G 25/16

(52) U.S. Cl. 239/70

(57) ABSTRACT

A portable knockdown above ground watering system and method for establishing a new lawn is provided. The system includes a compact water manifold structure comprising a manifold housing having a water inlet in fluid communication with a plurality of water outlets, the manifold structure enclosed in a portable case. A plurality of solenoid actuated valves are connected adjacent to and in fluid communication with each of the water outlets. A plurality of sprinkler heads may be connected in fluid communication to the manifold structure with removably connected outlet hoses.

### TECHNICAL FIELD

Exemplary embodiments of the present invention are directed to a method and apparatus for watering a lawn or other surface. More specifically, exemplary embodiments of the present invention are directed to a portable apparatus for watering a lawn that is situated above ground.

### BACKGROUND

There are known systems and methods for watering lawns. Maintenance of a healthy lawn or yard requires sufficient amounts of water to be properly distributed. Additionally, when planting a new lawn, additional watering may be required for desired growth. Most existing watering systems tend to fall into two general categories, in-ground or buried watering systems and above ground watering systems.

In-ground watering systems generally involve buried water supply lines and a number of permanently located sprinkler heads. Some sort of operating systems are used to operate these systems to provide for various types of watering parameters. For example some known systems may include an in-ground irrigation method and control system for watering a plurality of watering stations spaced about a lawn or garden. In another example, an in-ground watering system may have a plurality of buried valves which actuate pop up sprinklers. While in-ground systems do provide a satisfactory means for watering a lawn, they suffer from a number of disadvantages. For example, they are expensive to install, they can suffer from high frequency of repairs in climates where the buried lines are susceptible to freezing and cracking, and their permanence can adversely affect a homeowners future plans for landscaping or other building modifications.

Above ground watering systems and devices do not suffer from most of the disadvantages seen with in-ground systems. Most above ground systems typically involve a garden hose connected to a water sprinkling device which is positioned at a particular location. For example, many styles of oscillating or rotating sprinklers are known in the art. One of the most significant disadvantages of above ground systems involves the amount of responsibility placed on the user to have to move the devices to different locations and to remember to turn on and off the water which supplies the devices.

When starting a new lawn from either seeding existing ground or sodding the lawn, more water than normal may be required for desired growth. If a lawn is seeded, the germination times for most blends of grass will fall in the range of three to twenty-one days, with annual rye grass seed at the three day range and bluegrasses in the fourteen to twenty-one day range. If a lawn is sodded, the need exists for the sod to grow new roots. During this time period, which is usually the first three weeks, it is imperative that the entire new lawn is repetitively supplied with sufficient amounts of water or the sod or seed will fail.

In new home and commercial construction, landscaping and the establishment of a healthy lawn plays an important role in both sales and the potential liability of the contractor or individual responsible for laying down the initial sodding or seeding. Existing in-ground and above ground watering systems fail to provide an inexpensive and reliable watering system for the establishment of a new lawn. Therefore, the need exists for an inexpensive portable above ground watering system that can aid in the establishment of a new lawn during this critical time period.

Exemplary embodiments described hereinafter may remedy some or all of the aforementioned deficiencies found in the prior systems and methods of watering lawns.

### SUMMARY OF THE GENERAL INVENTIVE CONCEPT

Accordingly, exemplary embodiments may provide a portable above ground watering apparatus to use with a system and method for establishing or maintaining a new lawn.

Another object of this invention is to provide a watering apparatus that includes a minimal need for setup and takedown time and energy, while still maintaining portability.

Still another object of this invention is to provide an inexpensive watering system capable of automatic twenty-four hour a day operation during the establishment of a new lawn.

Yet another object of this invention is to provide a compact water manifold structure for use in an above ground watering system, the manifold structure having a low profile for inconspicuous ground level placement out in the lawn, which will reduce the lengths of hoses needed to connect from the manifold structure to the sprinkler heads.

Yet still another object of this invention is to provide a portable above ground watering system that is expandable and does not require the placement or use of extending high voltage wire or extension cords across a lawn or yard for increased safety.

Yet another object of this invention is to provide a portable irrigation system comprised of a controller and water manifold structure enclosed in a portable carrying case having a plurality of holes displaced around the case for accepting the water outlets and inlets for the water manifold.

To achieve the foregoing and other objectives, and in accordance with the purposes of the present invention a portable knockdown above ground watering system for establishing a new lawn is provided. The system includes a compact water housing comprising a water inlet in fluid communication with a plurality of water outlets. A plurality of solenoid actuated valves are connected adjacent to and in fluid communication with the water inlet and each of the water outlets, each solenoid actuated valve having a solenoid valve water outlet having means for removable engagement with a first end of an outlet hose. The solenoid actuated valves being electrically connected to a first control cable. The inlet hose being removably connected to a water source. A plurality of sprinkler heads may be provided. Each sprinkler head being removably connected to a second end of the outlet hose. A timer assembly is provided for electronically regulating the solenoid actuated valves for operation of the sprinkler heads.

In accordance with an aspect of the invention, a portable compact low profile water manifold structure for use with an above ground portable watering system is provided. The manifold structure is preferably comprised of a pair of mated mold structures positioned on top of one another or side by side. The manifold structure being mated to the electronically regulated solenoid actuated valves. The manifold structure, including the electronically regulated solenoid actuated valves having outlet ends which are removable connected to an outlet hose which is removable connected to the sprinklers.

Other objects, features and advantages of the invention will become more readily apparent upon reference to the following description when taken in conjunction with the accompanying drawings, which drawings illustrate several embodiments of the invention.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one example embodiment of the water manifold of the present invention;

FIG. 2 illustrates one example embodiment of the compact case for the water manifold and controller of the present invention;

FIG. 3 illustrates a top view of one example embodiment of the case of the present invention;

FIG. 4 illustrates a plan view of one example embodiment of the case of the present invention;

FIG. 5 illustrates a top view of one example embodiment of the invention having the controller and manifold enclosed;

FIG. 6 illustrates another top view of one example embodiment of the invention having the controller and manifold enclosed;

FIG. 7 illustrates a perspective view of an example embodiment of the water manifold of the present invention;

FIG. 8 illustrates an example diagram of multiple water manifolds of the present invention connected to provide expanded watering capabilities.

### DETAILED DESCRIPTION OF EXEMPLARY EMBODIMENT(S)

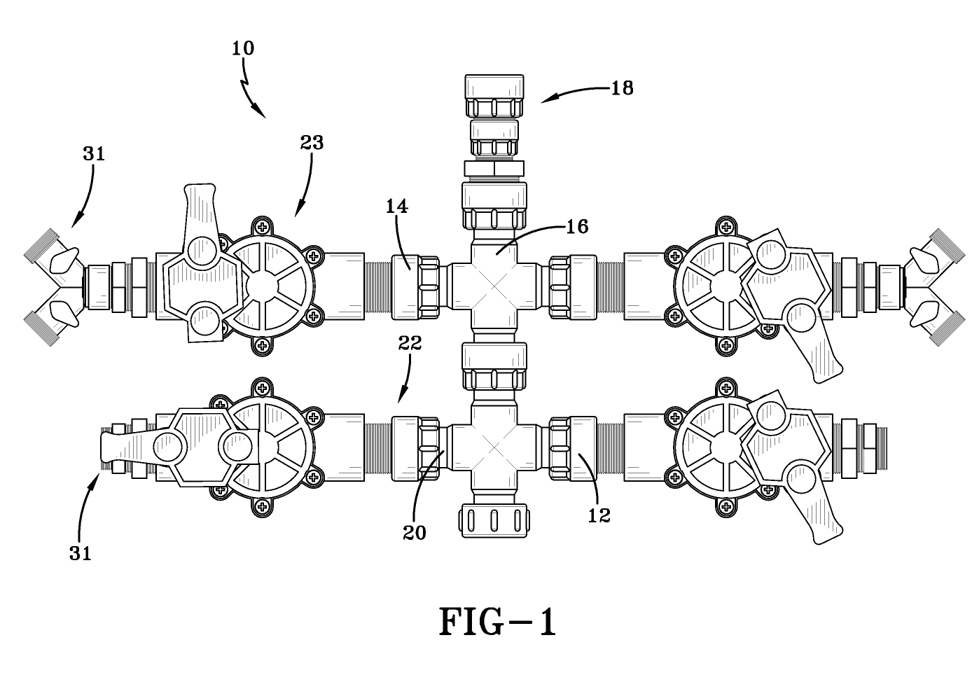

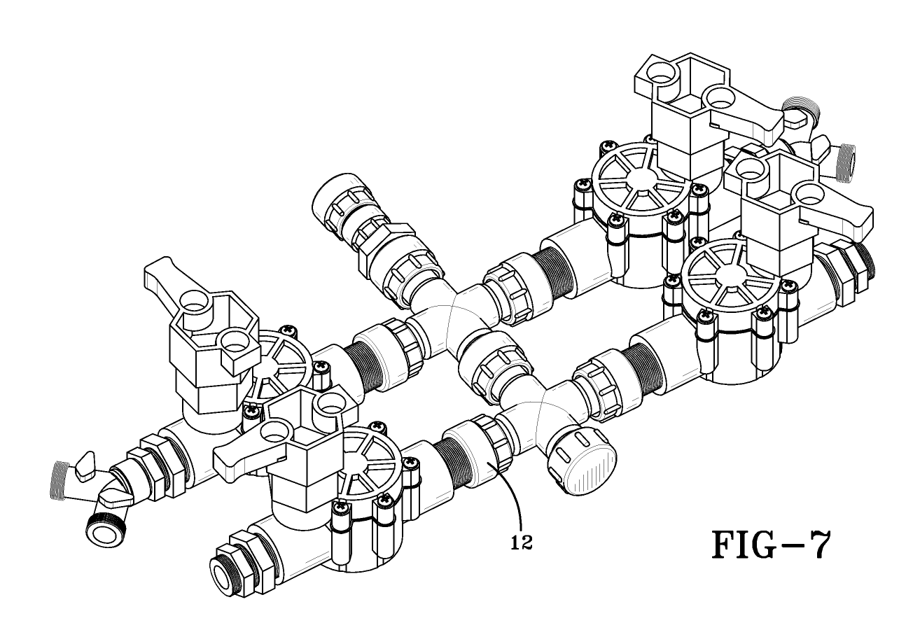

Referring now to the drawings, FIG. 1 and FIG. 7 illustrate one example embodiment of a portable knockdown above ground watering system 10 for establishing a new lawn. The system is shown in a disassembled knockdown configuration for compact storage and transportation within a box.

The system includes a compact water manifold structure 12 comprised of a manifold housing 14. The housing is preferably formed from a pair of mated mold structures formed of synthetic plastic material. The mold structures being positioned on top of one another or side by side, with the mated mold structures including a main tubular trunk 16 with a water inlet end or water inlet 18 and a series of tubular branches 20 longitudinally spaced along the main trunk and angled in staggered relation away from the main trunk. The tubular branches have outlet ends or water outlets 22. The mated mold structures are connected to one another by adhesive, such as epoxy, PVC glue or any other suitable adhesive.

Each mated mold structure preferably has a plurality of web portions or gussets in corresponding overlapping adjacency with the gussets of the other mated mold structure. The gussets having an aperture for securement of a fastening means, such as a screw or bolt, therethrough.

The water inlet is in fluid communication with a plurality of water outlets. A plurality of solenoid actuated valves 23 are connected adjacent to and in fluid communication with each of the water outlets. Preferably, the solenoid actuated valves are universal volt solenoid valves of conventional design.

The solenoid actuated valve preferably has a manual lever for manual operation of the valve. Each solenoid actuated valve has a solenoid valve water outlet having threaded means or a threaded portion for removable engagement with a first end of an outlet hose. The solenoid actuated valves for each manifold structure are electrically connected to a pigtail or first control cable. The inlet hose is removably connected to a water source, such as an outside water valve of a building. Preferably, the outlet hoses or inlet hoses are garden hoses of conventional design.

A plurality of sprinkler assemblies or sprinkler heads may be provided. Each sprinkler head is removably connected to a second end of the outlet hose. Any number of possible sprinkler assemblies may be used by this system. For example, oscillating or rotating sprinklers, impact sprinkler heads, and soaker hoses may be used. The sprinkler head is preferably formed of a plastic or non-corrosive material and has adjustments for adjusting the distance of water, the degree of spray, and level of mist.

Flexible waterproof control cables 26 may be provided for connection to the timer assembly 32.

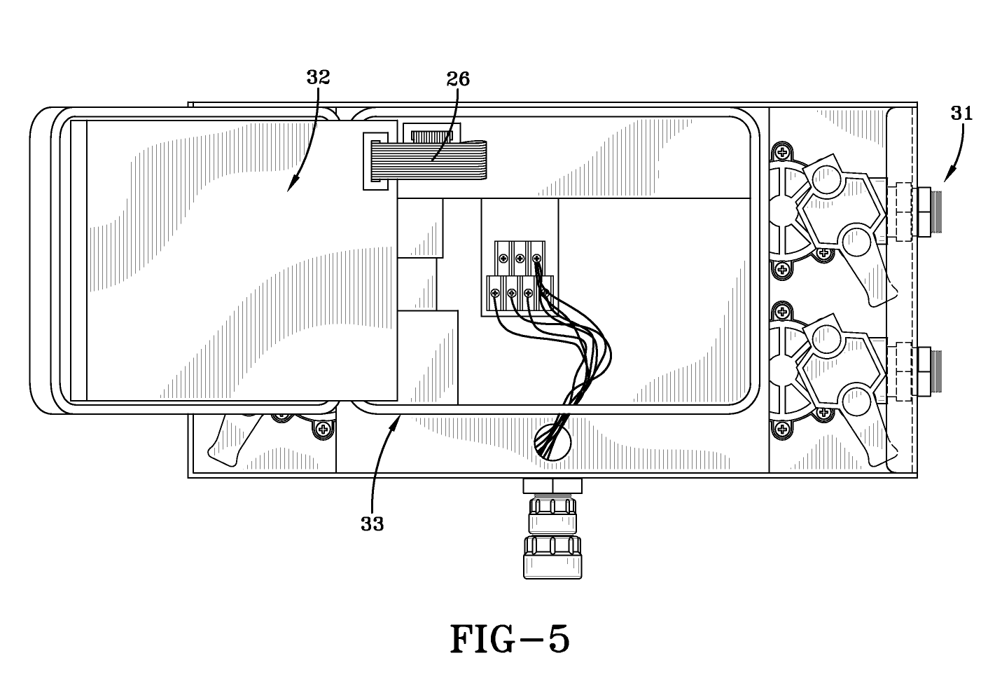

As best illustrated in FIG. 5, a timer means or timer assembly is provided for electronically regulating the solenoid actuated valves for operation of the sprinkler heads. The timer assembly being electrically connected to a timer control cable. A power supply line of the timer assembly is electrically connected to a power source. The timer assembly being in approximate adjacency, such as within ten feet or the length of the supply line, to the power source so that high voltage is disposed away from the new lawn. The timer assembly is housed within a waterproof box 33. It is to be understood that other styles of timer assemblies of conventional design may also be utilized with the system.

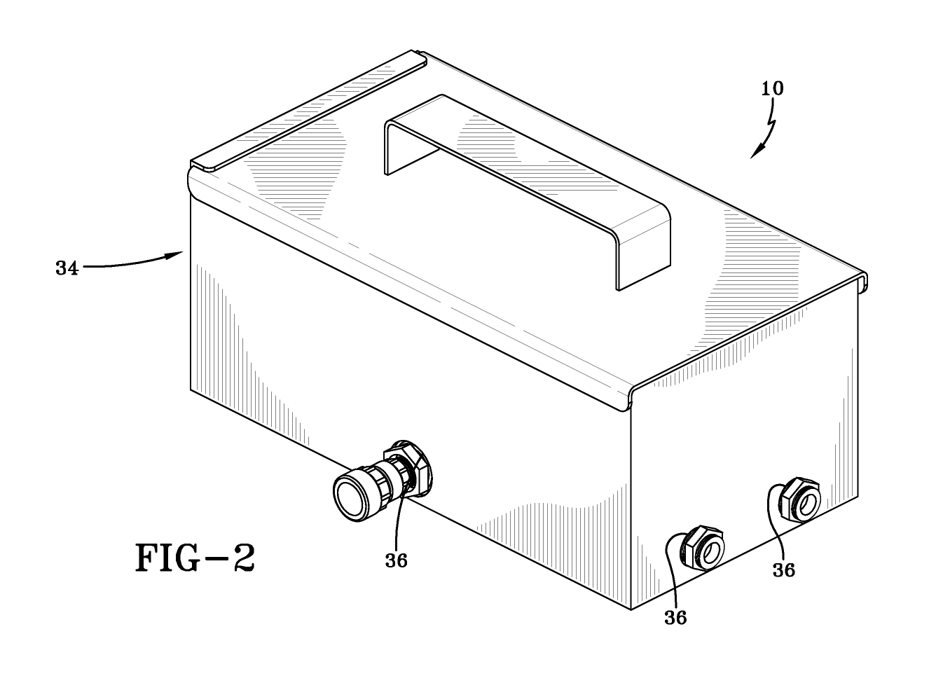

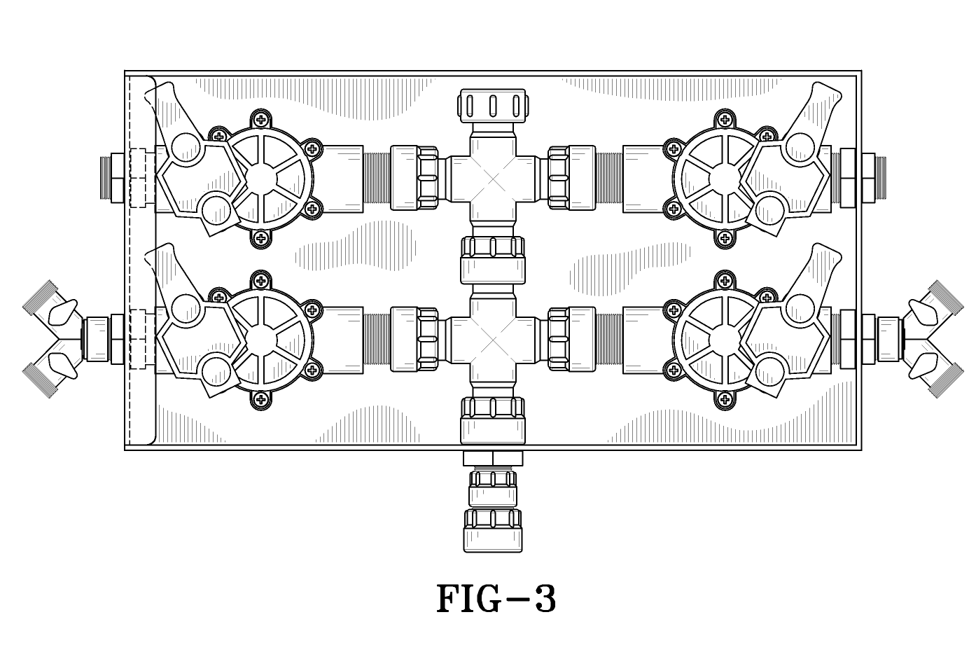

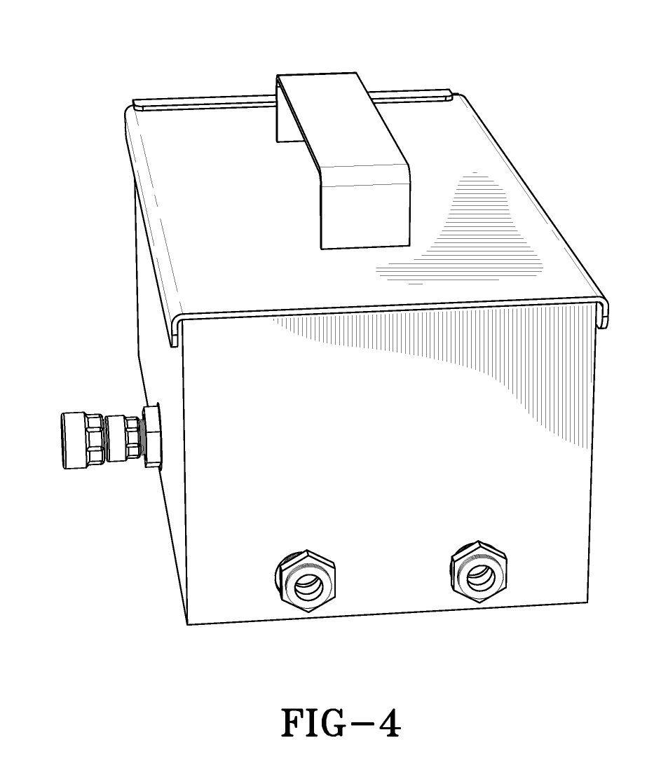

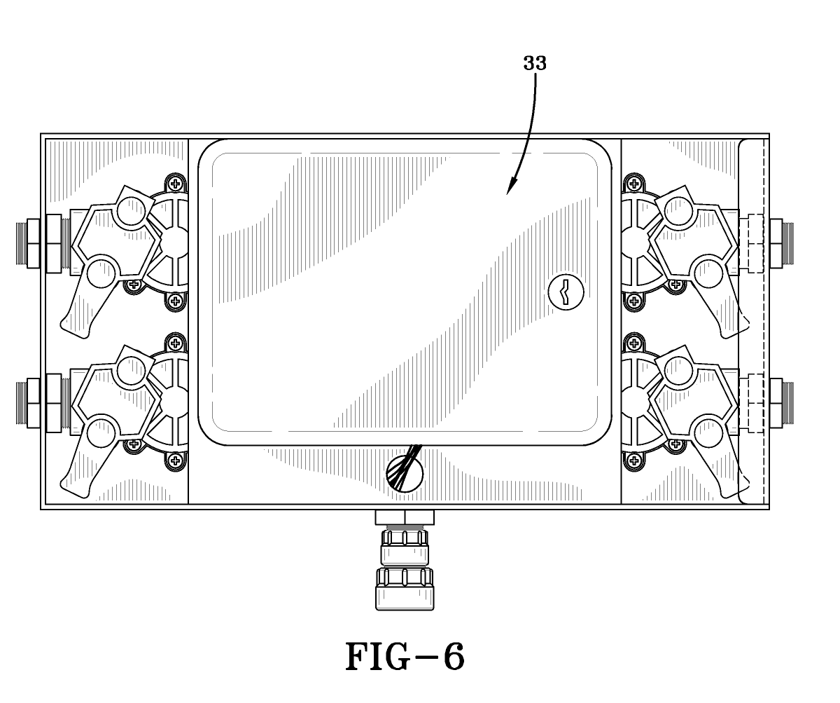

FIG. 2-FIG. 6 illustrate various views of one example embodiment of the compact case for the water manifold and controller of the present invention. In a preferred embodiment of the invention, the water manifold structure and the controller are enclosed in compact portable case 34 having openings 36 for accepting the water inlet and connections 31 to the outlet hoses.

This system of the present invention is preferably self contained and can be used anywhere there is a water source and standard household current. Setup involves connecting the system to a 110 v a/c outlet to power the electronic controller. A garden hose is then connected to the water inlet side of the system and then to a water spigot to provide a water source. Garden hoses are then connected to water outlets on the outside of the box (which are fed thru electronic valves that are activated by the electronic controller) and connected to lawn sprinklers that are then placed in the areas to be watered. The electronic controller is then programmed to run each valve/sprinklers for the desired length of time and to start and stop each program at the desired times just like a stationary/in ground lawn irrigation system. In one example standard system has the ability to run as few as 1 sprinkler or as many as 16 depending on water source pressure and volume.

In a method for establishing a new lawn with an above ground system, the method comprises the steps of: determining a number of watering zones within an area that the new lawn is to be established, the area of the watering zones being determined by the area of watering covered by a single sprinkler assembly; determining a number of available water supply lines for watering of the lawn; providing a number of compact water manifold structures and timer assemblies that will be required to supply water to the sprinkler assembly of each watering zone so that each watering zone may be watered a required amount per day with only one watering zone being watered off of one water supply line at a given time so that there is sufficient water pressure to fully operate the sprinkler assembly; and arranging the compact water manifold structures on the new lawn so that a minimum length of outlet hoses may be removably connected between the compact manifold structures and the sprinkler assembly of each watering zone.

The method may also comprise the step of positioning each timer assembly in approximate adjacency to a power source of the timer assembly so that high voltage is disposed away from the new lawn.

After the establishment of lawn is completed, which is usually around the time period of two weeks, the additional step may be completed of disassembling the watering system for compact storage within a box for transporting to a new location.

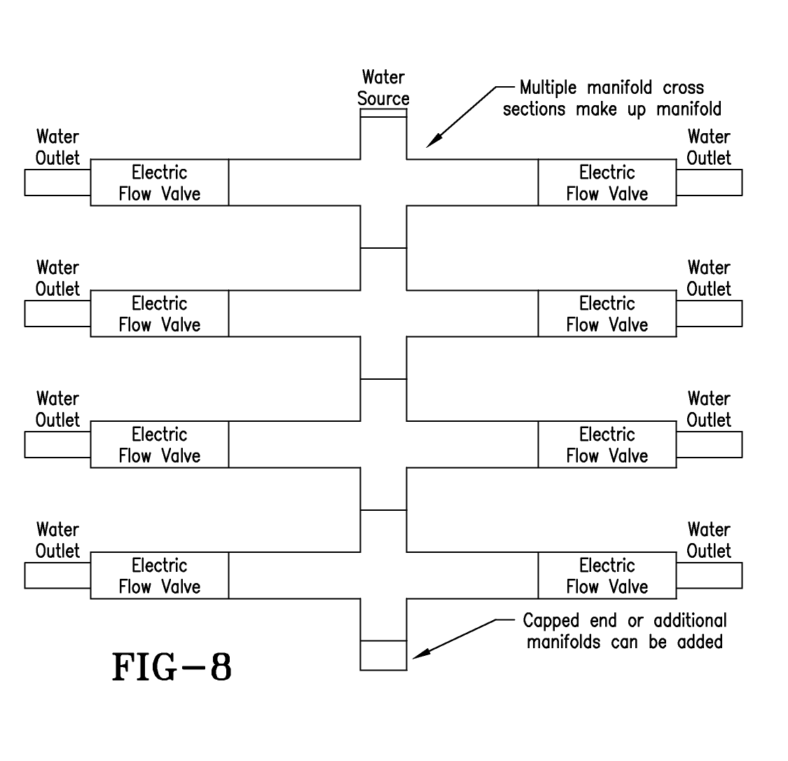

A feature of this system involves the expandability of the system to provide watering for areas of different sizes. The system can be used on smaller sites such as residential or can be expanded to accommodate larger sites such as commercial or athletic fields. This may be accomplished by adding additional valve/manifold assemblies and extra modules in the controller to add the number of watering zones necessary. FIG. 7 illustrates one example embodiment showing a plurality of manifold structures connected together in series. In another embodiment, an expanded system would involve stacking the manifolds on top of each other and contained in a portable case as described. See FIG. 8. The holes in the case can be added to accommodate the additional manifold structures stacked together. A higher zone capacity controller to accommodate more watering zones may be used. The box can also be enlarged to accommodate the extra manifolds and if necessary the larger controller.

In the preferred embodiment, a single timer assembly will operate corresponding solenoid actuated valves on two separate manifold structures connected in series. It is to be appreciated that numerous combinations of manifold structures and timer assemblies along with interconnecting control cables may be arranged for watering lawns of varied sizes.

While certain embodiments of the present invention are described in detail above, the scope of the invention is not to be considered limited by such disclosure, and modifications are possible without departing from the spirit of the invention as evidenced by the following claims:

What is claimed is:

1. A portable knockdown above ground watering system for establishing a new lawn, comprising in combination:
(a) a compact water manifold structure comprising a manifold housing having a water inlet in fluid communication with a plurality of water outlets, a plurality of solenoid actuated valves connected adjacent to and in fluid communication with each of the water outlets, each solenoid actuated valve having a solenoid valve water outlet having threaded means for removable engagement with a first end of an outlet hose, the water inlet adapted for removable connection to an inlet hose, the inlet hose being removably connected to a water source;
(b) timer for electronically regulating the solenoid actuated valves for operation of the sprinkler heads;
(c) a compact, portable, case for housing the manifold structure and timer, the case having openings for the water inlet and water outlets.

2. The combination of claim 1, further comprised of a plurality of sprinklers having sprinkler heads.

3. The combination of claim 1, wherein a 120 volt supply line of the timer means is electrically connected to a power source, the timer means being in approximate adjacency to the power source so that high voltage is disposed away from the new lawn, the timer means having a 24 volt output for low voltage above ground electrical passage along the flexible waterproof control cable.

4. The combination of claim 1, further comprising at least one additional water manifold structure in stacked configuration to the first water manifold structure and in fluid communication with the first manifold structure, wherein the combination is enclosed within the case.
